(19) United States
(12) Patent Application Publication
(10) Pub. No.: US 2025/0048095 A1
(43) Pub. Date: Feb. 6, 2025

(54) METHOD AND APPARATUS FOR MANAGING PENDING RE-AUTHENTICATION AND REAUTHORIZATION WITH DN-AAA SERVER

(71) Applicant: Samsung Electronics Co., Ltd., Suwon-si, Gyeonggi-do (KR)

(72) Inventor: Ashok Kumar NAYAK, Bangalore (IN)

(21) Appl. No.: 18/718,651

(22) PCT Filed: Jan. 9, 2023
(86) PCT No.: PCT/KR2023/000394

§ 371 Date: Jun. 11, 2024

(30) Foreign Application Priority Data
Jan. 10, 2022 (IN) 202241001223
Oct. 24, 2022 (IN) 2022 41001223

(51) Int. Cl. H04W 12/06; H04L 9/40; H04W 76/30

(52) U.S. Cl. CPC H04W 12/06; H04L 63/0892; H04W 76/30

(57) ABSTRACT

The disclosure relates to a fifth generation (5G) or sixth generation (6G) communication system for supporting a higher data transmission rate. Embodiments herein disclose methods and systems for managing a user equipment (102) in a wireless network (100). Embodiments disclose initiating, by a Session Management Function (SMF) (106), secondary re-authentication of the UE for existing protocol data unit (PDU) session based on at least one local policy at the SMF associated with DN or based on a configuration in the subscription profile of the UE for the associated DN. Embodiments disclose updating, by the SMF, at least one re-authentication status parameter to a pending state, on receiving a failure message from an Access and Mobility Management Function (AMF) (104) if the UE is unreachable. Embodiments disclose triggering, by the SMF, the re-authentication of the UE for the same existing PDU session, on identifying by the AMF that the UE is reachable.

### TECHNICAL FIELD

Embodiments disclosed herein relate to secondary authentication and authorization of a user equipment (UE) for establishing a session with the Data Network (DN). More particularly, the disclosure relates to managing the pending re-authentication and re-authorization for the related established session in a wireless network.

### BACKGROUND ART

Fifth generation (5G) mobile communication technologies define broad frequency bands such that high transmission rates and new services are possible, and can be implemented not only in “Sub 6 GHZ” bands such as 3.5 GHZ, but also in “Above 6 GHZ” bands referred to as mm Wave including 28 GHZ and 39 GHz. In addition, it has been considered to implement sixth generation (6G) mobile communication technologies (referred to as Beyond 5G systems) in terahertz (THz) bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (cMBB), Ultra Reliable Low Latency Communications (URLLC), and massive Machine-Type Communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, New Radio (NR) User Equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Solution to Problem

This disclosure relates to wireless communication networks, and more particularly to a terminal and a communication method thereof in a wireless communication system.

The principal object of the embodiments herein is to disclose methods and systems for managing secondary authentication and authorization of a User Equipment (UE) in a wireless network, when the UE is initiating session establishment with a data network.

Further object of the embodiments herein is to disclose methods and systems for managing pending re-authentication and re-authorization for the established session.

Another object of the embodiments herein is to disclose methods and systems for performing secondary re-authentication and re-authorization initiated by DN-AAA server or the SMF that has not been successfully executed.

### Advantageous Effects of Invention

Aspects of the disclosure are to address at least the above-mentioned problems and/or disadvantages and to provide at least the advantages described below. Accordingly, an aspect of the disclosure is to provide efficient communication methods in a wireless communication system.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 depicts an example scenario, wherein the UE is able to access the existing PDU session without going through the secondary re-authentication and re-authorization, triggered either by the DN-AAA server of the SMF, according to prior arts;

FIG. 2 is a block diagram depicting various components of a wireless network for managing UE in the wireless network, according to embodiments as disclosed herein;

FIG. 3 depict an example scenario, wherein the SMF can update the result based on the failure information from the AMF and trigger re-authentication again when UE becomes reachable, according to embodiments as disclosed herein; and

FIG. 4 is a flow diagram depicting a method for managing the user equipment in the wireless network, according to embodiments as disclosed herein.

FIG. 5 illustrates various hardware components of a network entity, according to the embodiments as disclosed herein;

FIG. 6 illustrates various hardware components of a UE, according to the embodiments as disclosed herein;

FIG. 7 illustrates various hardware components of a base station, BS, according to the embodiments as disclosed herein;

Throughout the drawings, it should be noted that like reference numbers are used to depict the same or similar elements, features, and structures.

### BEST MODE FOR CARRYING OUT THE INVENTION

Accordingly, the embodiments herein provide methods and systems for managing a User Equipment (UE) in a wireless network. A method disclosed herein includes initiating secondary re-authentication of the UE for existing protocol data unit (PDU) session based on at least one local policy at SMF and on the SMF receiving at least one re-authentication request from a Data Network Authentication Authorization and Accounting (DN-AAA) server. The method further includes updating at least one re-authentication status parameter to a pending state, on receiving a failure message from an Access and Mobility Management Function (AMF) if the UE is unreachable. The method further includes triggering the re-authentication of the UE for the same existing PDU session, on identifying by the AMF that the UE is reachable.

Accordingly, the embodiments herein provide a session management function (SMF). The SMF (106) includes a re-authentication controller (112) coupled to the processor (120), configured to initiate a secondary re-authentication of a user equipment (UE) for existing protocol data unit (PDU) session based on at least one local policy at SMF and on the SMF receiving at least one re-authentication request from a Data Network Authentication Authorization and Accounting (DN-AAA) server. Further, SMF can update at least one re-authentication status parameter to a pending state, on receiving a failure message from an Access and Mobility Management Function (AMF) if the UE is unreachable. Further, the SMF can trigger the re-authentication of the UE for the same existing PDU session, on identifying by the AMF that the UE is reachable.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### MODE FOR THE INVENTION

This application is based on and derives the benefit of Indian Provisional Application 20/224,1001223, the contents of which are incorporated herein by reference.

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to their bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Before undertaking the DETAILED DESCRIPTION below, it can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the disclosure. For example, unless otherwise defined, the technical terms or scientific terms used in the disclosure shall have the ordinary meaning understood by those with ordinary skills in the art to which the disclosure belongs.

It should be understood that “first”, “second” and similar words used in the disclosure do not express any order, quantity or importance, but are only used to distinguish different components.

As used herein, any reference to “an example” or “example”, “an implementation” or “implementation”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing. As such, “a portion of” a thing includes the entire thing as a special case, i.e., the entire thing is an example of a portion of the thing.

As used herein, the term “set” means one or more. Accordingly, a set of items can be a single item or a collection of two or more items.

In this disclosure, to determine whether a specific condition is satisfied or fulfilled, expressions, such as “greater than” or “less than” are used by way of example and expressions, such as “greater than or equal to” or “less than or equal to” are also applicable and not excluded. For example, a condition defined with “greater than or equal to” may be replaced by “greater than” (or vice-versa), a condition defined with “less than or equal to” may be replaced by “less than” (or vice-versa), etc.

It will be further understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. In addition, the technical schemes of the embodiments of the application can be applied to future-oriented communication technologies. In addition, the technical schemes of the embodiments of the application can be applied to future-oriented communication technologies.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

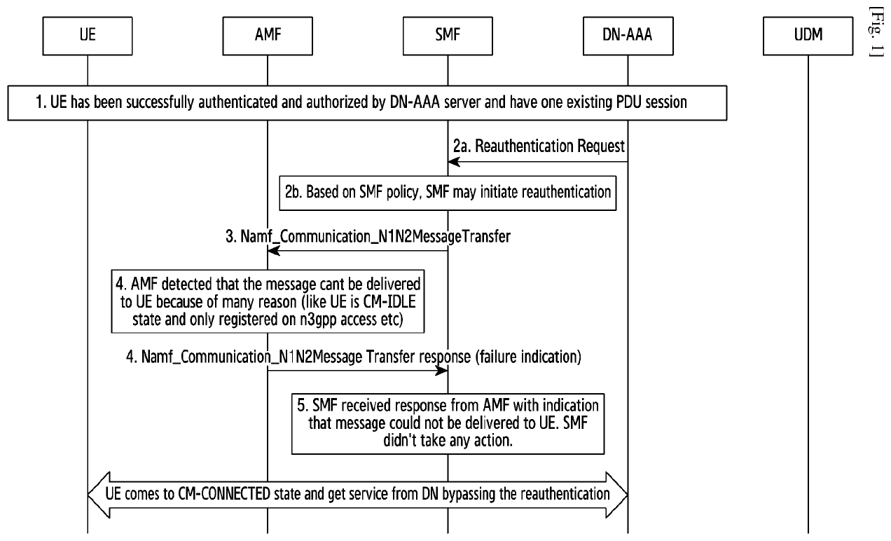

The embodiments herein provide methods and systems for managing secondary authentication and authorization of a User Equipment (UE) in a wireless network, when the UE is initiating session establishment with a data network. Referring now to the drawings, and more particularly to FIGS. 1 to 7, where similar reference characters denote corresponding features consistently throughout the figures, there are shown at least one embodiment.

Embodiments herein disclose methods and systems for managing user equipment in the wireless network. Embodiments disclose initiating the pending re-authentication and re-authorization of the established session, by either the DN-AAA server or SMF. Further, embodiments herein disclose secondary re-authentication and re-authorization of the UE that has not been successfully executed. On obtaining successful re-authentication and re-authorization, the UE may be configured to use the existing session. On unsuccessful re-authentication and re-authorization, the SMF may release the existing PDU session and update the DN-AAA server. The SMF on identifying that the UE is unreachable can update the re-authentication result parameter to pending state. The SMF can trigger the re-authentication of the UE for the existing PDU session on identifying by the AMF that UE is reachable.

UE becomes reachable for the network when it starts sending any uplink message and hence AMF will inform the SMF that now UE is reachable because of its next uplink activity.

Secondary authentication occurs between the User Equipment (UE) and the Data Network (DN) outside the mobile operator domain. Previously, on establishing the user plane tunnel between the UE and the DN, DNs may conduct the access control by themselves without the support of mobile operator. Thus, allowing malicious UEs to invoke authentication service provided by the DN resulting in Denial of Services (DOS) attack.

Currently, fifth generation (5G) networks allow multiple mobile operators to delegate the authentication and authorization to a third-party hosting DN. This procedure can be executed during the establishment of user plane connection after the successful primary authentication. The secondary authentication and authorization can be performed during protocol data unit (PDU) session establishment based on the session management function (SMF) policy associated with the DN. Further, secondary authentication and authorization can be performed based on the configuration in the subscription profile of the UE for the associated DN. Therefore, the SMF can perform the operations of extensible authentication protocol (EAP) authenticator, but the authentication and authorization messages can be exchanged between the UE and the data network authentication authorization and accounting (DN-AAA) server.

In the existing mechanism, the DN-AAA server or the SMF may initiate the secondary re-authentication and/or re-authorization. If re-authentication and re-authorization is successful, then the existing session will be continued, otherwise the SMF may release the PDU session and update the DN-AAA server.

In the existing mechanism, the UE can be registered in non-third generation Partnership Project (N-3GPP) access network, the connection management (CM) state at the access mobility management function (AMF) can be CM-IDLE. The AMF receives the re-authentication and/or re-authorization message from the SMF, initiated by the SMF or the DN-AAA server. The AMF may be unable to send the message to the UE and hence re-authentication and/or reauthorization cannot be executed itself.

The UE on reaching the connected state, can use the service from the DN through the existing PDU session. Also, if the UE uses a new PDU session establishment for the same DN, the SMF may skip the authentication and authorization based on the earlier stored success authentication & authorization result. Thereby, resulting in successful assignment of new PDU session by the UE with the missed re-authentication and/or reauthorization, probability that re-authentication and/or re-authorization would have been failed, which had been triggered earlier but could not be executed.

FIG. 1 depicts an example scenario, wherein the UE is able to access the existing PDU session without going through the secondary re-authentication and re-authorization, triggered either by the DN-AAA server of the SMF, according to prior arts;

Referring to FIG. 1, a depict an example scenario, wherein the UE participate secondary re-authentication and re-authorization, triggered either by the DN-AAA server or the SMF. Secondary authentication and authorization may take place between UE & DN-AAA server after successful primary authentication and authorization. Primary authentication is based on the mechanism used to authenticate the user equipment 102 on the mobile network of the selected mobile network operator. Examples of mechanism used to provide primary authentication to the UE 102 may include, but not limited to credentials token, smart cards, ciphering keys, codes such as personal identification number (PIN), personal unlocking key (PUK), information and subscription related information and the like. Primary authorization can be provided to the UE to avail the services from the wireless network. Primary authorization referred herein may be any mechanism used to authorize the user equipment to avail services from the wireless network. The mechanism to provide primary authorization to the UE may include but not limited to the third party authorization function, authorizing entity, any other authorization mechanism to authorize the UE to avail service from the network.

As illustrated in FIG. 1, the UE can be successfully authenticated and authorized by the DN-AAA server, with the existing protocol data unit (PDU) session. The secondary authentication and authorization can be initiated during PDU session establishment based on the SMF policy associated with the DN or based on the configuration in the subscription profile of the UE for the associated DN. Further, the DN-AAA server and SMF can initiate the secondary re-authentication, by forwarding message to UE through AMF. The AMF, on identifying that the messages cannot be delivered to the UE (as it is in connection management idle state (CM-IDLE)), updates the SMF with a corresponding indication. The SMF on receiving response from the AMF indicating that message could not be delivered to UE remains unhandled without taking any actions. Therefore, SMF remains unhandled, which may lead the UE successfully continuing to get services from the DN without getting re-authenticated.

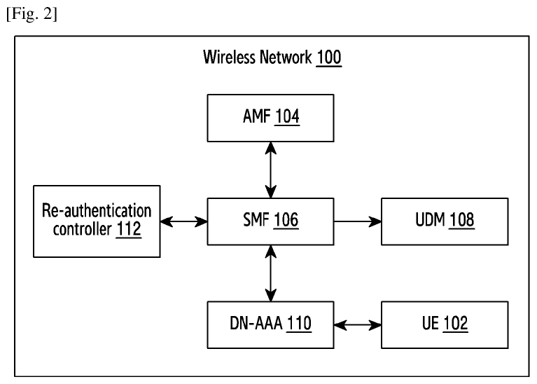

FIG. 2 is a block diagram depicting various components of a wireless network for managing UE in the wireless network, according to embodiments as disclosed herein.

Referring to FIG. 2, the wireless network 100 referred herein can be at least one of a 3rd Generation Partnership Project (3GPP) network, a Centralized Radio Access Network (RAN) network, a cloud RAN network, a virtualized RAN network, a Long Term Evolution (LTE)/4G network, an LTE advanced network, a Fifth Generation/New radio (5G) network, Worldwide Interoperability for Microwave Access (WiMAX/IEEE 802.16), Wi-Fi (IEEE 802.11), a 5G based wireless communication system, a 4G based wireless communication system, Wi-Fi Direct, a millimeter wave (mmWave) network, a centimeter-wave 5G network, and so on.

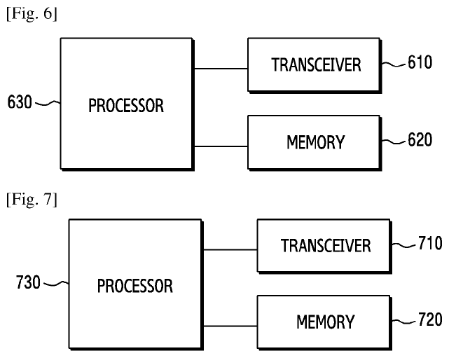

The wireless network 100 comprises at least one User Equipment (UE) 102, an Access and Mobility Management Function (AMF) 104, a Session Management Function (SMF) 106, a Unified Data Management (UDM) 108, a Data Network Authentication Authorization and Accounting (DN-AAA) server (110) and a re-authentication controller 112. However, the components of the wireless network 100 are not limited thereto. For example, the wireless network 100 may include more or fewer components than those described above. In addition, the wireless network 100 corresponds to the network entity of the FIG. 5 and the UE 102 corresponds to the base station of the FIG. 6.

The core network can be at least one of an Evolved Packet Core (EPC), a 5G core (5GC), or the like. The core network can be connected to the at least one Base Station. The core network can be configured to connect the at least one UE 102 to an external data network. Examples of the external data network can be, but is not limited to, the Internet, a Packet Data Network (PDN), an Internet Protocol (IP) Multimedia Core Network Subsystem, and so on.

As illustrated in FIG. 2, the AMF 104 can be configured to receive connection and session related information of the UE 102. The AMF can be configured to handle registration, connection establishment, reach ability and mobility management tasks of the UE. The AMF 104 can be configured to register the UE, which can register and deregister with the 5G network. The UE 102 can be configured to complete the registration procedure to receive authorization to use the 5G network. The AMF 104 on providing registration service can create a UE context within the network. The AMF 104 can be configured to establish a connection and release the control plane signaling between the UE 102 and the AMF 104, wherein the UE 102 can use the signaling to configure the UE from connection management (CM) idle to connected state.

The AMF 104 can be configured to provide a reachable service to the UE 102, ensuring that the UE 102 is always reachable in the network. It can provide a paging service, wherein the UE can be configured to establish a mobile terminated connection. Paging a UE 102 which is in the CM-idle state can trigger the UE to initiate a service request procedure and establish a connection by providing signal(s), before moving into the CM-connected state.

The AMF can be configured to manage mobility of the UE in the network. The AMF 104 can maintain location of the UE in the network. The UE 102 can be configured to register on a periodic basis, for performing registration of the UE 102 on the network. Periodic updates of the UE 102 can track the location of the UE 102 on the network. The UE can be configured to update current locations, which are triggered if the UE 102 moves outside the current registration area.

The SMF 106 is a fundamental element of the 5G Service-Based Architecture (SBA). The SMF 106 can be configured to interact with the decoupled data plane, creating, updating and removing PDU sessions and managing session context with the User Plane Function (UPF). The UPF carries the user data which is a fundamental component of the 5G network and can be configured in the data transfer in the 5G network.

Messages related to the session management can be forwarded over the reference interface to the SMF. The SMF 106 is part of the control plane function within the 5G network, mainly responsible for PDU session management, which comprises setup, modification and release of PDU sessions. The Control plane function of the 5G network can be configured to carry the signaling traffic in the network. PDU sessions management requires the SMF to complete signaling towards, UE 102, base station, and UPF.

The UE 102 referred herein can be a device capable of authenticating and authorizing to a Data Network Authentication Authorization Accounting (DN-AAA server) 110 with an existing PDU session. The UE 102 can be registered in N3GPP access with the CM-IDLE state at the AMF for receiving re-authentication and/or re-authorization message from the SMF or DN-AAA server for the existing PDU session for which secondary authentication and authorization has been already taken place successfully. The UE 102 may be configured with secondary authentication and authorization information and participate only after successful primary authentication from the network. Primary authentication referred herein may be any mechanism used to authenticate the user equipment 102 on the mobile network of the selected mobile network operator. Examples of mechanism used to perform primary authentication of the UE 102 may include, but not limited to credentials token, smart cards, ciphering keys, codes such as personal identification number (PIN), personal unlocking key (PUK), information and subscription related information and the like. Examples of the UE 102 can be, but is not limited to, a mobile phone, a smart phone, a tablet, a personal digital assistant (PDA), a laptop, a computer, a wearable computing device, a vehicle infotainment device, an Internet of Things (IoT) device, a Wireless Fidelity (Wi-Fi) router, a USB dongle, and so on. The UE 102 can establish the reliable connection with the at least one base station for exchanging the control and data traffic with the external data network.

UE 102 can participate in secondary authentication and authorization during PDU session establishment. Secondary authentication and authorization can be performed based on the SMF policy associated with the DN or based on the configuration in the subscription profile of the UE 102 for the associated DN. Hence, the authentication and authorization messages can be exchanged between the UE 102 and the DN-AAA server 110.

G networks may allow mobile operators to delegate the authentication and authorization to the third-party hosting DN using secondary authentication. Secondary authentication can be performed by establishing user plane connection after a successful primary authentication. User plane can be interchangeably called with the data plane, which carries the network user traffic. The user plane protocol between the UE 102 and the base station comprises sub-layers such as PDCP (Packet data convergence protocol), RLC (radio link control) and Medium Access Control (MAC).

In another embodiment, the DN-AAA server 110 or the SMF 106 may initiate secondary re-authentication and/or re-authorization. If the re-authentication and re-authorization is successful, then the existing session will be continued, otherwise the SMF 106 may release the existing PDU session and update the DN-AAA server. The UE 102 can be registered in the 5G network and the Connection Management (CM) state at the AMF can be CM-IDLE, during which the AMF can receive the re-authentication and/or re-authorization message from the SMF. Re-authentication and/or re-authorization can be initiated either by the SMF or the DN-AAA server. For an instance, consider that the AMF 104 is unable to send the message to the UE 102 and the re-authentication and/or re-authorization cannot be executed by itself. The AMF 104, on identifying that the UE is unreachable or the UE is in idle CM state, can provide failure message to the SMF 106. Hence, on receiving the failure indication from the AMF 104, the SMF can update the re-authentication status to pending state.

In an embodiment, the AMF 104, on identifying that UE is reachable or the UE comes back to CM-CONNECTED state, inform the SMF and then SMF trigger with the re-authentication of the UE with the same existing PDU session. The UEs 102 may continue to use the services from the DN through the existing PDU session. If the UE 102 use the new PDU session establishment for the same DN, the SMF can skip the authentication and authorization based on the earlier stored result.

As illustrated in FIG. 2, the DN-AAA server 110 can be configured to handle UE requests for accessing resources in the network. The DN-AAA server 110 can provide authentication, authorization and accounting of services in the network. The DN-AAA server 110 can be configured to interact with network, gateway servers, databases and directories comprising information related to UE 102. The DN-AAA server 110 can be configured to access the network or resources configured with the UE 102. The UE can be authenticated using various mechanisms to access the DN-AAA server 110. The mechanism for obtaining authentication may include but not limited to using credentials, third party authentication, authentication entities, and the like.

The DN-AAA server 110 can be configured to authorize the UE to access the wireless network. For an instance, the UE can be provided with read-only accesses to the network, while other UEs can be configured with read/write access to the network. Therefore, the DN-AAA server 110 can provide various UEs with various access policies. One or more authenticated UEs may have abilities to access certain resources or make changes, while other UEs can be authorized to have far more freedom to access the network.

The DN-AAA server 110 can be configured with accounting, for security purpose. The DN-AAA server 110 can be configured to collect information of the UE trying to access the network. The DN-AAA server 110 can collect whether authentication of the UE 102 was successful or not. The DN-AAA server 110 can collect the amount of time an authenticated session lasted, amount of data transmitted and received during an authenticated session, commands performed by the UE within the authenticated session and the like. Hence, the DN-AAA server 110 can be configured with authenticated and authorized UEs 102.

As illustrated in FIG. 2, the AMF 104 on identifying that the UE is unreachable or UE is in CM-IDLE state can provide failure message to the SMF. Thus, with the failure indication from the AMF 104, the SMF can update re-authentication status to pending state. Therefore, pending status of the re-authentication can be stored locally, Unstructured Data Storage Function (UDSF) and in Unified Data Management (UDM) indicating the failure indication from the AMF. Failure notification from the AMF 104 indicates that the UE is unreachable, as the UE is in idle state, or the UE is not in an accessible location in the network.

In an embodiment herein, the pending state of the UE can be stored in the UDM which is a single and centralized storage unit in the network. The UDM resides on the control plane and utilizes services to communicate between the user plane and the control plane. The UDM manages data for access authorization, user registration and data network profiles. The UDM can be configured to retrieve and provide data to other network functions to manage the UE related data. The UDM can provide UE related data to the UE, wherein the SMF which allocates and manages user sessions on the network using the received UE related data.

In an embodiment herein, the pending state of the UE can be stored in the UDSF which supports data storage for stateless network functions. The USDF can be configured to offer storage of unstructured context and state information to the core network functions across the service-based architecture (SBA). The UDSF can be configured to provide services for storage and retrieval of unstructured data for 5G core network functions.

The Re-authentication controller 112 includes a processing unit. The processing unit can be at least one of a single processer, a plurality of processors, multiple homogeneous or heterogeneous cores, multiple Central Processing Units (CPUs) of different kinds, microcontrollers, special media, and other accelerators. The processing unit can be configured to control operations of the UE 102 by executing the program stored in the memory. The DN-AAA server 110 or the SMF 106 may initiate secondary re-authentication and/or re-authorization. The controller 112 can be configured to initiate re-authentication on receiving a signal from the DN-AAA or the SMF. If the re-authentication and re-authorization is successful, then the existing session will be continued by the UE 102, otherwise the SMF 106 may release the existing PDU session and update the DN-AAA server 110.

The memory can store authenticated and authorized UEs 102 registered in the network. The memory 210 may include one or more computer-readable storage media. The memory 210 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory may, in some examples, be considered a non-transitory storage medium. The term “non-transitory” may indicate that the storage medium is not embodied in a carrier wave or a propagated signal. However, the term “non-transitory” should not be interpreted to mean that the memory is non-movable. In some examples, the memory can be configured to store larger amounts of information than the memory. In certain examples, a non-transitory storage medium may store data that can, over time, change (e.g., in Random Access Memory (RAM) or cache).

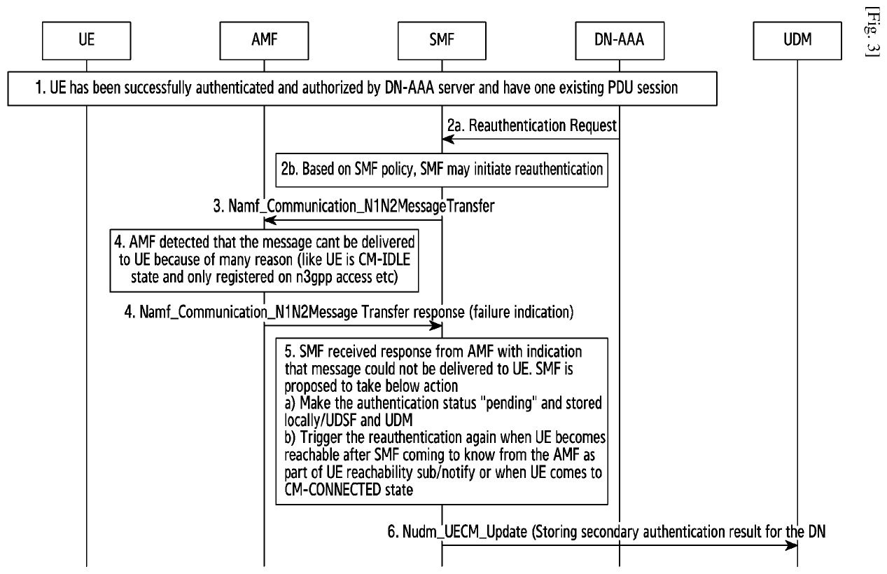

FIG. 3 depict an example scenario, wherein the SMF can update the result based on the failure information from the AMF and trigger re-authentication again when UE becomes reachable, according to embodiments as disclosed herein.

Referring to FIG. 3, the secondary re-authentication and/or re-authorization can be performed. The DN-AAA server 110 can forward the re-authentication request to the SMF 106 and the SMF may initiate re-authentication based on the SMF policy.

In another embodiment, the SMF 106 can be configured to send message to the AMF for establishing communication with the UE 102. The AMF 104, on identifying that the message cannot be delivered to the UE, can update the SMF 106 with the failure indication. The unsuccessful delivery of message to the UE 102 may be due to reasons, such as, but not limited to, the UE 102 currently being in CM-IDLE state, the UE 102 registered only on N3GPP access, the UE 102 in unreachable mode and the like. Hence, the SMF 106 on receiving notifications from the AMF 104, that the message could not be delivered to the UE 102, can update authentication result to the pending state. The authentication result can be stored locally or in the Unstructured Data Storage Function (UDSF) and the Unified Data Management (UDM).

Therefore, the SMF, on identifying unsuccessful re-authentication of the UE 102 (based on at least one operator and DN policy), releases the existing PDU session and notifies the DN-AAA server 110. Hence, during secondary re-authentication, the unreachability of the UE 102 can be identified based on at least one operator and the DN policy. The SMF 106 can release the existing PDU session of the UE 102 and notify the DN-AAA 110 server about the unreachability of the UE 102. Further, if the re-authentication result is unsuccessful, the SMF can release the existing PDU session and notify the DN-AAA server 110.

In an embodiment herein, during secondary re-authentication, the SMF 106, on receiving a notification from the AMF that the UE is unreachable, can inform the DN-AAA server 110 that the UE 102 is unreachable. The AMF, on identifying that the UE is unreachable in the secondary re-authentication, can notify the SMF 106. Hence, the SMF 106 can update the authentication result to pending in the UDSF and/or the UDM. Therefore, based on the notification from the SMF 106, the DN-AAA server 110 may decide to either retain the PDU session or to discard the PDU session.

In an embodiment herein, consider that the UE 102 becomes unreachable; then the SMF can mark the re-authentication result as pending and initiate re-authentication at the next uplink activity. The SMF 106, on receiving re-authentication request from the DN-AAA server 110, can be configured to notify the DN-AAA server 110 that the re-authentication cannot be performed, along with the error message.

In an embodiment herein, the SMF can trigger re-authentication, on identifying that the UE is reachable. The AMF 104, on identifying that the UE 102 is reachable, can notify the SMF 106. The UE 102 can be determined to be reachable based on the current CM connected state and reachability state of the UE on the network.

In an embodiment herein, the AMF 104 can identify that the UE 102 is reachable using the existing UE reach ability subscribe and notification mechanism. Hence, the AMF 104 can be configured to notify the SMF 106 to trigger the re-authentication procedure after the UE 102 becomes reachable. The AMF 104 can be configured to identify the reachability of the UE 102 using the existing notification operation or the CM-CONNECTED state. The AMF 104 can notify the reach ability of the UE 102 to the SMF 106. Thus, the SMF 106 can trigger the re-authentication procedure again after the UE 102 becomes reachable using the existing UE reach ability subscribe/notify mechanism. Further, the CM-CONNECTED state of the UE 102 can be stored in the UDM with the secondary authentication result for the DN.

An embodiment herein discloses re-authentication and/or reauthorization of the UE on the wireless network. The SMF, on receiving failure information from the AMF indicating that the UE is unreachable, can update the authentication and/or authorization result to pending state. The authentication result can be stored locally and/or in the UDSF and in the UDM. Further, the SMF can trigger the re-authentication procedure on identifying that the UE is reachable. The AMF can notify the SMF that the UE is reachable using the UE reachability subscribe and notification mechanism. Further, the SMF, on identifying that the re-authentication is unsuccessful based on operator and DN policy, the SMF may release the existing PDU session of the UE 102.

As illustrated in FIG. 3, the SMF can be configured to initiate re-authentication procedure for secondary re-authentication triggered either by the DN-AAA server or the SMF. Step 1 illustrates that the UE has been successfully authenticated and authorized by the DN-AAA server 110 through the AMF 104. The AMF can be configured to handle registrations, connection establishment, reachability and mobility management tasks of the UE 102. The AMF 104 can be configured to register the UE, which can further register and de-register with the 5G network. The AMF 104 can be configured to provide a reachable service to the UE 102, ensuring that the UE is reachable in the network.

Steps 2a and 2b of FIG. 3, illustrates that DN-AAA server 110 and the SMF 106 can initiate the re-authentication procedure. Steps 2a and 2b deals with initiating the pending re-authentication and re-authorization of the established session by either the DN-AAA server 110 or the SMF 106. Further, in step 2a of the FIG. 3, illustrates that the DN-AAA server 110 can forward the re-authentication request to the SMF 106. In step 2b which illustrates, that the SMF on receiving the re-authentication request from the DN-AAA server 110, can initiate the re-authentication procedure based on the SMF policy.

Step 3 illustrates that SMF can be configured to send message to the AMF. AMF 104 can be configured to use various other interfaces to communicate with other elements, nodes or NFs. For an instance, N1, N2 and N11 interfaces can be configured between the AMF 104 and SMF 106 to communicate with each other. Each of the AMF interfaces can be configured to receive NIN2 message transfer from the SMF 106. For an instance, the AMF 104 can be configured to receive Namf_communication_NIN2_MessageTransfer from the SMF 106.

Step 4 illustrates that the AMF 104, on receiving NIN2 message transfer from the SMF 106 can detect whether the UE is in reachable or unreachable state. The AMF 104 can be configured to send detecting message to the UE and can identify whether the UE can receive the detecting or not. The AMF 104 can be configured to identify that the detecting message could not be delivered to the UE 102, which may be due to reasons, such as, but not limited to, the UE 102 currently being in CM-IDLE state, the UE 102 registered only on N3GPP access, the UE 102 in unreachable mode and the like. Therefore, the AMF 104, on identifying the message cannot be delivered to the UE, can update the SMF 106 with the failure indication.

In step 5, the SMF 106 can be configured to receive Namf_Communication_NIN2Message Transfer_response message with the failure indication that the UE 102 is unreachable. Hence, SMF 106, can be configured to receive response from the AMF 104, with the indication that detecting message cannot be delivered to UE 102. The SMF 106 can update the authentication status to pending and the status can be stored locally, UDSF and UDM. The SMF 106, can be configured to trigger the re-authentication again when the UE 102 becomes reachable after the AMF 104, on identifying the UE 102 is reachable. The AMF 104 can notify the SMF 106 that the UE 102 is reachable using the existing sub/notify operation or when the UE becomes CM connected state.

In step 6, the SMF 106 can be configured to store the secondary authentication result in the UDM. The UDM can be configured to receive message from SMF using Nudm interface. Hence, the SMF 106 can be configured to send Nudm_UECM_update message storing the result of secondary authentication of the UE 102 to the UDM 108.

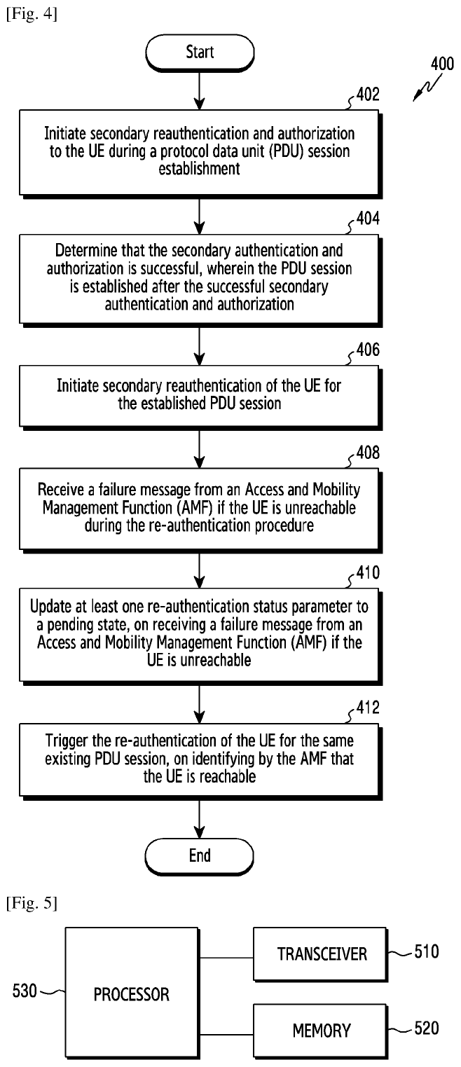

FIG. 4 is a flow diagram depicting a method for managing the UE in the wireless network, according to embodiments as disclosed herein.

Referring to FIG. 4, at step 402, the method includes initiating, by a Session Management Function (SMF), secondary authentication and authorization to the UE during a protocol data unit (PDU) session establishment.

At step 404, the method includes determining, by the SMF, that the secondary authentication and authorization is successful, wherein the PDU session is established after the successful secondary authentication and authorization;

At step 406, the method includes initiating, by the SMF, secondary re-authentication of the UE for the established PDU session;

At step 408, the method includes receiving, by the SMF, a failure message from an Access and Mobility Management Function (AMF) if the user is unreachable during the re-authentication procedure;

At step 410, the method includes updating, by the SMF, at least one secondary re-authentication status parameter to a pending state, on receiving the failure message; and

At step 412, the method includes triggering, by the SMF, the secondary re-authentication of the UE for the established PDU session, at the next uplink activity.

FIG. 5 illustrates various hardware components of a network entity, according to the embodiments as disclosed herein.

Referring to FIG. 5, the network entity includes a transceiver (510), a memory (520), and a processor (530). The transceiver (510), the memory (520), and the processor (530) of the network entity may operate according to a communication method of the network entity described above. However, the components of the terminal are not limited thereto. For example, the network entity may include fewer or a greater number of components than those described above. However, the components of the network entity are not limited thereto. For example, the network entity may include more or fewer components than those described above. In addition, the processor (530), the transceiver (510), and the memory (520) may be implemented as a single chip. Also, the processor (530) may include at least one processor. Furthermore, the network entity of FIG. 5 corresponds to the wireless network 100 of FIG. 2.

The network entity includes at least one entity of a core network. For example, the network entity includes an AMF, a session management function (SMF), a policy control function (PCF), a network repository function (NRF), a user plane function (UPF), a network slicing selection function (NSSF), an authentication server function (AUSF), a UDM and a network exposure function (NEF), but the network entity is not limited thereto.

The transceiver (510) collectively refers to a network entity receiver and a network entity transmitter, and may transmit/receive a signal to/from a base station or a UE. The signal transmitted or received to or from the base station or the UE may include control information and data. In this regard, the transceiver (510) may include an RF transmitter for up-converting and amplifying a frequency of a transmitted signal, and an RF receiver for amplifying low-noise and down-converting a frequency of a received signal. However, this is only an example of the transceiver (510) and components of the transceiver (510) are not limited to the RF transmitter and the RF receiver.

The transceiver (510) may receive and output, to the processor (530), a signal through a wireless channel, and transmit a signal output from the processor (530) through the wireless channel.

The memory (620) may store a program and data required for operations of the network entity. Also, the memory (620) may store control information or data included in a signal obtained by the network entity. The memory (620) may be a storage medium, such as a ROM, a RAM, a hard disk, a CD-ROM, and a DVD, or a combination of storage media.

The processor (630) may control a series of processes such that the network entity operates as described above. For example, the transceiver (610) may receive a data signal including a control signal, and the processor (630) may determine a result of receiving the data signal.

FIG. 6 illustrates a structure of a base station according to an embodiment of the disclosure.

As shown in FIG. 6, the base station according to an embodiment may include a transceiver 610, a memory 620, and a processor 630. The transceiver 610, the memory 620, and the processor 630 of the base station may operate according to a communication method of the base station described above. However, the components of the base station are not limited thereto. For example, the base station may include more or fewer components than those described above. In addition, the processor 630, the transceiver 610, and the memory 620 may be implemented as a single chip. Also, the processor 630 may include at least one processor.

The transceiver 610 collectively refers to a base station receiver and a base station transmitter, and may transmit/receive a signal to/from a terminal (UE) or a network entity. The signal transmitted or received to or from the terminal or a network entity may include control information and data. The transceiver 610 may include a RF transmitter for up-converting and amplifying a frequency of a transmitted signal, and a RF receiver for amplifying low-noise and down-converting a frequency of a received signal. However, this is only an example of the transceiver 610 and components of the transceiver 610 are not limited to the RF transmitter and the RF receiver.

Also, the transceiver 610 may receive and output, to the processor 630, a signal through a wireless channel, and transmit a signal output from the processor 630 through the wireless channel.

The memory 620 may store a program and data required for operations of the base station. Also, the memory 620 may store control information or data included in a signal obtained by the base station. The memory 620 may be a storage medium, such as read-only memory (ROM), random access memory (RAM), a hard disk, a CD-ROM, and a DVD, or a combination of storage media.

The processor 630 may control a series of processes such that the base station operates as described above. For example, the transceiver 610 may receive a data signal including a control signal transmitted by the terminal, and the processor 630 may determine a result of receiving the control signal and the data signal transmitted by the terminal.

FIG. 7 illustrates a structure of a UE according to an embodiment of the disclosure.

As shown in FIG. 7, the UE according to an embodiment may include a transceiver 710, a memory 720, and a processor 730. The transceiver 710, the memory 720, and the processor 730 of the UE may operate according to a communication method of the UE described above. However, the components of the UE are not limited thereto. For example, the UE may include more or fewer components than those described above. In addition, the processor 730, the transceiver 710, and the memory 720 may be implemented as a single chip. Also, the processor 730 may include at least one processor. Furthermore, the UE of FIG. 7 corresponds to the UE 102 of the FIG. 2.

The transceiver 710 collectively refers to a UE receiver and a UE transmitter, and may transmit/receive a signal to/from a base station or a network entity. The signal transmitted or received to or from the base station or a network entity may include control information and data. The transceiver 710 may include a RF transmitter for up-converting and amplifying a frequency of a transmitted signal, and a RF receiver for amplifying low-noise and down-converting a frequency of a received signal. However, this is only an example of the transceiver 710 and components of the transceiver 710 are not limited to the RF transmitter and the RF receiver.

Also, the transceiver 710 may receive and output, to the processor 730, a signal through a wireless channel, and transmit a signal output from the processor 730 through the wireless channel.

The memory 720 may store a program and data required for operations of the UE. Also, the memory 720 may store control information or data included in a signal obtained by the UE. The memory 720 may be a storage medium, such as read-only memory (ROM), random access memory (RAM), a hard disk, a CD-ROM, and a DVD, or a combination of storage media.

The processor 730 may control a series of processes such that the UE operates as described above. For example, the transceiver 710 may receive a data signal including a control signal transmitted by the base station or the network entity, and the processor 730 may determine a result of receiving the control signal and the data signal transmitted by the base station or the network entity.

In one embodiment, a method performed by a first network entity in a wireless communication system, the method comprising: receiving, from a second network entity, first information indicating that a user equipment (UE) is unreachable, during a re-authentication for the UE; and transmitting, to a data network authentication authorization and accounting (DN-AAA) server, second information indicating that the UE is not reachable for the re-authentication.

In one embodiment, further comprising: releasing a protocol data unit (PDU) session based on the re-authentication being unsuccessful; and transmitting, to the DN-AAA server, third information indicating that the re-authentication is unsuccessful.

In one embodiment, further comprising: marking the re-authentication as pending in case that the UE becomes unreachable; and initiating the re-authentication at a next uplink activity.

In one embodiment, wherein the first network entity is a session management function (SMF) entity, the second network entity is an access and mobility management function (AMF) entity.

In one embodiment, a method performed by a second network entity in a wireless communication system, the method comprising: transmitting, to a first network entity, first information indicating that a user equipment (UE) is unreachable, during a re-authentication for the UE, wherein second information indicating that the UE is not reachable for the re-authentication is transmitted to a data network authentication authorization and accounting (DN-AAA) server.

In one embodiment, wherein a protocol data unit (PDU) session is released based on the re-authentication being unsuccessful, and wherein third information indicating that the re-authentication is unsuccessful is transmitted to the DN-AAA server.

In one embodiment, wherein the re-authentication is marked as pending in case that the UE becomes unreachable, and wherein the re-authentication is initiated at a next uplink activity.

In one embodiment, wherein the first network entity is a session management function (SMF) entity, the second network entity is an access and mobility management function (AMF) entity.

In one embodiment, a first network entity in a wireless communication system, the first network entity comprising: a transceiver; and at least one processor operatively coupled with the transceiver and configured to: receive, from a second network entity, first information indicating that a user equipment (UE) is unreachable, during a re-authentication for the UE; and transmit, to a data network authentication authorization and accounting (DN-AAA) server, second information indicating that the UE is not reachable for the re-authentication.

In one embodiment, further comprising: release a protocol data unit (PDU) session based on the re-authentication being unsuccessful; and transmit, to the DN-AAA server, third information indicating that the re-authentication is unsuccessful.

In one embodiment, further comprising: mark the re-authentication as pending in case that the UE becomes unreachable; and initiate the re-authentication at a next uplink activity.

In one embodiment, wherein the first network entity is a session management function (SMF) entity, the second network entity is an access and mobility management function (AMF) entity.

In one embodiment, a second network entity in a wireless communication system, the second network entity comprising: a transceiver; and at least one processor operatively coupled with the transceiver and configured to: transmit, to a first network entity, first information indicating that a user equipment (UE) is unreachable, during a re-authentication for the UE, wherein second information indicating that the UE is not reachable for the re-authentication is transmitted to a data network authentication authorization and accounting (DN-AAA) server.

In one embodiment, wherein a protocol data unit (PDU) session is released based on the re-authentication being unsuccessful, and wherein third information indicating that the re-authentication is unsuccessful is transmitted to the DN-AAA server.

In one embodiment, wherein the first network entity is a session management function (SMF) entity, the second network entity is an access and mobility management function (AMF) entity.

Those skilled in the art will understand that the various illustrative logical blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

In the above-described embodiments of the disclosure, all operations and messages may be selectively performed or may be omitted. In addition, the operations in each embodiment do not need to be performed sequentially, and the order of operations may vary. Messages do not need to be transmitted in order, and the transmission order of messages may change. Each operation and transfer of each message can be performed independently.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system. The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors cooperating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. A storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

While the disclosure has been shown and described with reference to various embodiments thereof, it will be understood by those skilled in the art that various changes in form and details may be made therein without departing from the spirit and scope of the disclosure as defined by the appended claims and their equivalents.

The various actions, acts, blocks, steps, or the like in the method and the flow diagram 400 may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

1. A method performed by a first network entity in a wireless communication system, the method comprising:
receiving, from a second network entity, first information indicating that a user equipment (UE) is unreachable, during a re-authentication for the UE; and
transmitting, to a data network authentication authorization and accounting (DN-AAA) server, second information indicating that the UE is not reachable for the re-authentication.

2. The method of claim 1, further comprising:
releasing a protocol data unit (PDU) session based on the re-authentication being unsuccessful; and
transmitting, to the DN-AAA server, third information indicating that the re-authentication is unsuccessful.

3. The method of claim 1, further comprising:
marking the re-authentication as pending in case that the UE becomes unreachable; and
initiating the re-authentication at a next uplink activity.

4. The method of claim 1,
wherein the first network entity is a session management function (SMF) entity, the second network entity is an access and mobility management function (AMF) entity.

5. A method performed by a second network entity in a wireless communication system, the method comprising:
transmitting, to a first network entity, first information indicating that a user equipment (UE) is unreachable, during a re-authentication for the UE,
wherein second information indicating that the UE is not reachable for the re-authentication is transmitted to a data network authentication authorization and accounting (DN-AAA) server.

6. The method of claim 5,
wherein a protocol data unit (PDU) session is released based on the re-authentication being unsuccessful, and wherein third information indicating that the re-authentication is unsuccessful is transmitted to the DN-AAA server.

7. The method of claim 5,
wherein the re-authentication is marked as pending in case that the UE becomes unreachable, and wherein the re-authentication is initiated at a next uplink activity.

8. The method of claim 5,
wherein the first network entity is a session management function (SMF) entity, the second network entity is an access and mobility management function (AMF) entity.

9. A first network entity in a wireless communication system, the first network entity comprising:
a transceiver; and
at least one processor operatively coupled with the transceiver and configured to:
receive, from a second network entity, first information indicating that a user equipment (UE) is unreachable, during a re-authentication for the UE; and
transmit, to a data network authentication authorization and accounting (DN-AAA) server, second information indicating that the UE is not reachable for the re-authentication.

10. The first network entity of claim 9, further comprising:
release a protocol data unit (PDU) session based on the re-authentication being unsuccessful; and
transmit, to the DN-AAA server, third information indicating that the re-authentication is unsuccessful.

11. The first network entity of claim 9, further comprising:
mark the re-authentication as pending in case that the UE becomes unreachable; and
initiate the re-authentication at a next uplink activity.

12. The first network entity of claim 9,
wherein the first network entity is a session management function (SMF) entity, the second network entity is an access and mobility management function (AMF) entity.

13. A second network entity in a wireless communication system, the second network entity comprising:
a transceiver; and
at least one processor operatively coupled with the transceiver and configured to:
transmit, to a first network entity, first information indicating that a user equipment (UE) is unreachable, during a re-authentication for the UE,
wherein second information indicating that the UE is not reachable for the re-authentication is transmitted to a data network authentication authorization and accounting (DN-AAA) server.

14. The second network entity of claim 13,
wherein a protocol data unit (PDU) session is released based on the re-authentication being unsuccessful, and wherein third information indicating that the re-authentication is unsuccessful is transmitted to the DN-AAA server.

15. The second network entity of claim 13,
wherein the first network entity is a session management function (SMF) entity, the second network entity is an access and mobility management function (AMF) entity.
